(19) United States
(12) Patent Application Publication
(10) Pub. No.: US 2016/0070458 A1
(43) Pub. Date: Mar. 10, 2016

(54) METHOD AND DEVICE FOR MANAGING AND CONFIGURING FIELD DEVICES IN AN AUTOMATION INSTALLATION

(71) Applicant: ABB TECHNOLOGY AG, Zuerich (CH)

(72) Inventors: Dirk Wagener, Stadthagen (DE); Christoph Welte, Neu-Ulm (DE); Marcus Heeg, Kaisersesch (DE); Wolfgang Mahnke, Hettenleidelheim (DE); Marko Schlueter, Espelkamp (DE)

(21) Appl. No.: 14/847,048

(22) Filed: Sep. 8, 2015

(30) Foreign Application Priority Data
Sep. 8, 2014 (DE) 10 2014 013 313.3

(51) Int. Cl. G06F 3/0484; H04L 12/24; G06F 3/0482

(52) U.S. Cl. CPC G06F 3/04847; G06F 3/0482; H04L 41/22; H04L 41/0879

(57) ABSTRACT

A method and device for managing and configuring field devices in an automation installation with a configuration tool operative to physically detect a field device in the automation installation, logically incorporate it into the automation installation, and configure it in the automation installation, the configuration tool resorting for this purpose to a predefined first field-device-specific information packet which at least partially describes the functions and data of the field device and for this purpose has a predetermined set of predefined graphical elements. The configuration tool may have a set of freely defined graphical elements, each freely defined graphical element corresponding to a predefined graphical element of the field-device-specific information packet, the functionality and appearance of the freely defined graphical elements being freely definable, and the configuration tool being operative to extract the predefined graphical elements from the field-device-specific information packet and to replace them with freely defined graphical elements.

### CROSS-REFERENCE TO RELATED APPLICATIONS

Priority is claimed to German Patent Application No. DE 10 2014 013 313.3, filed on Sep. 8, 2014, the entire disclosure of which is hereby incorporated by reference herein.

### FIELD

The invention relates to a method and a device for managing and configuring field devices in an automation installation. The invention can be used, in particular, in process automation or machine control for controlling processes and/or installation components.

### BACKGROUND

Automation systems for controlling a technical process or a technical installation usually comprise a control device (PLC) which is integrated in a group of a multiplicity of intelligent electrical devices. Intelligent electronic devices are microprocessor-based devices, for example protective and control devices, motor protective devices, intelligent switches and voltage regulators, frequency converters, pressure and temperature measuring transducers, flowmeters and actuators.

The article “FDI Device Integration—Best of Both Worlds”, at edition June 2010, pages 16 to 19, discloses the practice of integrating field devices into an automation installation using the FDI concept (Field Device Integration IEC-62769). The basis of this concept is the provision of information for configuring field devices in a device-specific FDI packet. This FDI packet comprises a firmly predefined amount of information which consists of a device definition, business logic, a user interface description and user interface plug-ins. The device definition comprises management information and the device model. The business logic describes the communication logic for the device and is used to ensure consistency of the device model. The user interface description describes the presentation of the device parameters and device functions. The user interface plug-ins are programmed components of interface portions for displaying the device parameters and functions.

When configuring field devices by means of EDD (electronic device description) technology IEC 61804, a device manufacturer provides an EDD which comprises information relating to the communication with the device, the business logic and the user interfaces, that is to say which input masks should be displayed for a user. The business logic includes, for example, when which parameters can be written.

FDI technology uses these EDD mechanisms and provides the concept of the FDI package which, in addition to an EDD, may also include other information such as a user handbook or else so-called UIPs (user interface plug-in) which provide further user interfaces in other technologies, for example .NET assemblies, which, in contrast to EDD-based user interfaces, consist of programmed code compiled for a component.

FDI packets are typically created by device manufacturers and are used by system manufacturers to integrate and configure the devices from the device manufacturers in their system.

In addition to an individual user element having different parameters, graphs and other elements, new windows and dialogs may also be defined in the EDD. In this case, a host has certain freedoms and can display a plurality of menus defined in the EDD in different windows at the same time, for example, or else user interfaces of different device entities.

### SUMMARY

An aspect of the invention provides a managing and configuring device for one or more field devices in an automation installation with a configuration tool, the managing and configuring device comprising: a unit configured to a predefined first field-device-specific information packet; and a predetermined set of predefined graphical elements, wherein the configuration tool is operative to physically detect a field device in the automation installation, to logically incorporate the field device into the automation installation, wherein the configuration tool is operative to configure the field device in the automation installation, wherein the configuration tool resorts, for this purpose, to the predefined first field-device-specific information packet, which at least partially describes functions and data of the field device, and wherein the configuration tool, for this purpose, includes the predetermined set of predefined graphical elements, wherein the configuration tool includes a set of graphical elements, each graphical element of the configuration tool corresponding to a predefined graphical element of the field-device-specific information packet, wherein a functionality and appearance of the graphical elements of the configuration tool can be freely defined, and wherein the configuration tool is operative to extract the predefined graphical elements from the predefined first field-device-specific information packet and to replace them with graphical elements of the configuration tool.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows a basic illustration of a configuration tool

FIG. 2 shows a basic illustration of method steps in the configuration tool.

### DETAILED DESCRIPTION

An aspect of the invention provides a device for managing and configuring field devices in an automation installation, the clarity and handling of which are improved.

An aspect of the invention is based on an apparatus for managing and configuring field devices in an automation installation with a configuration tool which is operative to physically detect a field device in the automation installation, to logically incorporate it into the automation installation and to configure it in the automation installation, the configuration tool resorting for this purpose to a predefined first field-device-specific information packet which at least partially describes the functions and data of the field device and for this purpose has a predetermined set of predefined graphical elements.

An aspect of the invention provides for the configuration tool to have a set of graphical elements, each graphical element of the configuration tool corresponding to a predefined graphical element of the field-device-specific information packet, the functionality and appearance of the graphical elements of the configuration tool being able to be freely defined, and for the configuration tool to be operative to extract the predefined graphical elements from the field-device-specific information packet and to replace them with graphical elements of the configuration tool.

Another feature of the invention provides for the graphical elements of the configuration tool to be linked to functionalities. Such a functionality may involve outputting a visualized time profile of a measurement variable to a printer.

In addition, the method provides for the field-device-specific information packet to be analyzed, for the predefined graphical elements whose field-device-specific use is predefined in the information packet to be determined, for the predefined graphical elements of the field-device-specific information packet to be replaced with the graphical elements of the configuration tool, and for the graphical elements of the configuration tool to be displayed on request.

The freely definable graphical elements of the configuration tool advantageously allow a high degree of flexibility which meets the individual requirements for managing and configuring field devices in an automation installation. A high degree of clarity is achieved in this case. An enlarged and/or differently colored representation of field devices and/or their functions makes it possible to highlight precisely that element which is particularly important in the context of the automation installation.

According to another feature of the invention, the freely definable graphical elements of the configuration tool are loaded into the configuration tool from a data storage medium. In this case, provision may be made for the freely definable graphical elements to be provided by the device manufacturer. A configuration tool which supports the freely definable graphical elements provided by the device manufacturer is operative to replace the predefined graphical elements of the field-device-specific information packet with the freely definable graphical elements and to display the freely definable graphical elements instead of the predefined graphical elements of the field-device-specific information packet.

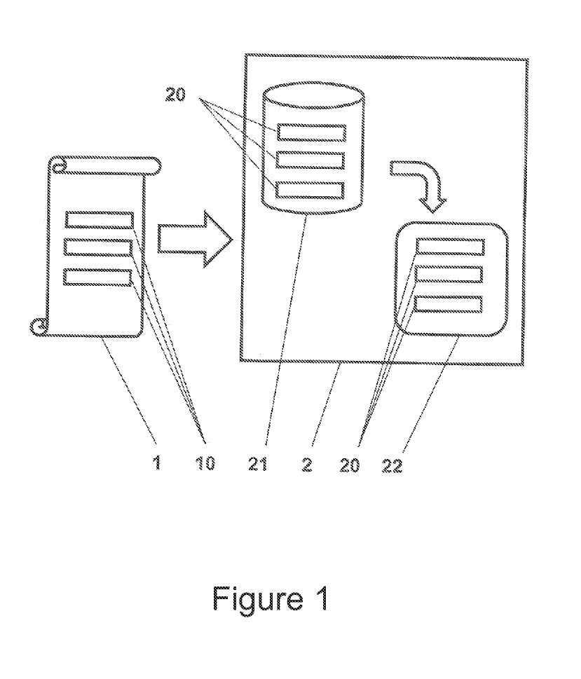

FIG. 1 is a basic illustration of a configuration tool 2. The configuration tool 2 has a display 22 for displaying graphical elements 20 for managing and configuring field devices in an automation installation. For this purpose, a field-device-specific information packet 1, which at least partially describes the functions and data of the field device and for this purpose has a predetermined set of predefined graphical elements 10, is loaded into the configuration tool 2 for each field device to be incorporated in the automation installation. In particular, this field-device-specific information packet 1 is in the form of an EDD file.

The configuration tool 2 has a set of graphical elements 20, each graphical element 20 of the configuration tool 2 corresponding to a predefined graphical element 10 of the field-device-specific information packet 1. The graphical elements 20 of the configuration tool 2 are stored in a memory 21 of the configuration tool 2.

The functionality and appearance of the graphical elements 20 of the configuration tool 2 are freely definable. An enlarged and/or differently colored representation of field devices and/or their functions makes it possible to highlight precisely that element which is particularly important in the context of the automation installation. This achieves a high degree of flexibility and clarity which meets the individual requirements for managing and configuring field devices in an automation installation.

The configuration tool 2 is operative to extract the predefined graphical elements 10 from the field-device-specific information packet 1 and to replace them with graphical elements 20 of the configuration tool 2.

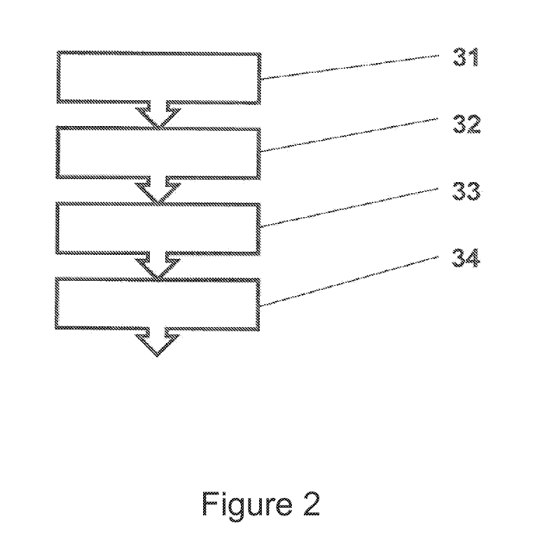

For this purpose, according to FIG. 2, the field-device-specific information packet 1 is analyzed in a first method step 31. In this case, the predefined graphical elements 10 in the field-device-specific information packet 1 are cataloged.

In a subsequent, second method step 32, the predefined graphical elements 10 whose field-device-specific use is predefined in the information packet 1 are determined.

In a subsequent, third method step 33, the predefined graphical elements 10 of the field-device-specific information packet 1 are replaced with the graphical elements 20 of the configuration tool 2 which are stored in the memory 21 of the configuration tool 2.

Finally, in a fourth method step 34, the graphical elements of the configuration tool 2 are displayed on the display 22 on request.

A particular configuration of the invention may provide for the freely definable graphical elements 20 of the configuration tool 2 to be loaded into the configuration tool 2 from a data storage medium which is usually provided by the device manufacturer. A configuration tool 2 which supports the freely definable graphical elements 20 provided by the device manufacturer is operative to replace the predefined graphical elements 10 of the field-device-specific information packet 1 with the freely definable graphical elements 20 and to display the freely definable graphical elements 20 instead of the predefined graphical elements 10 of the field-device-specific information packet 1.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B, and C” should be interpreted as one or more of a group of elements consisting of A, B, and C, and should not be interpreted as requiring at least one of each of the listed elements A, B, and C, regardless of whether A, B, and C are related as categories or otherwise. Moreover, the recitation of “A, B, and/or C” or “at least one of A, B, or C” should be interpreted as including any singular entity from the listed elements, e.g., A, any subset from the listed elements, e.g., A and B, or the entire list of elements A, B, and C.

### LIST OF REFERENCE SYMBOLS

1 Field-device-specific information packet
10 Predefined graphical elements
2 Configuration tool
20 Graphical elements of the configuration tool
21 Memory
22 Display
31 . . . 34 Method steps

1. A managing and configuring device for one or more field devices in an automation installation with a configuration tool, the managing and configuring device comprising:
a unit configured to a predefined first field-device-specific information packet; and
a predetermined set of predefined graphical elements,
wherein the configuration tool is operative to physically detect a field device in the automation installation, to logically incorporate the field device into the automation installation,
wherein the configuration tool is operative to configure the field device in the automation installation,
wherein the configuration tool resorts, for this purpose, to the predefined first field-device-specific information packet, which at least partially describes functions and data of the field device, and
wherein the configuration tool, for this purpose, includes the predetermined set of predefined graphical elements,
wherein the configuration tool includes a set of graphical elements, each graphical element of the configuration tool corresponding to a predefined graphical element of the field-device-specific information packet,
wherein a functionality and appearance of the graphical elements of the configuration tool can be freely defined, and
wherein the configuration tool is operative to extract the predefined graphical elements from the predefined first field-device-specific information packet and to replace them with graphical elements of the configuration tool.

2. The device of claim 1, wherein the graphical elements of the configuration tool are linked to functionalities.

3. A method for managing and configuring field devices in an automation installation with a configuration tool, the configuration tool being operative to physically detect a field device in the automation installation, to logically incorporate the field device into the automation installation, and to configure the field device in the automation installation, the configuration tool resorting, for this purpose, to a predefined first field-device-specific information packet which at least partially describes functions and data of the field device and, for this purpose, includes a predetermined set of predefined graphical elements , the method comprising:
analyzing the field-device-specific information packet;
determining the predefined graphical elements whose field-device-specific use is predefined in the information packet;
replacing the predefined graphical elements of the field-device-specific information packet with graphical elements of the configuration tool; and
displaying the graphical elements of the configuration tool on request.

4. The method of claim 3, further comprising:
loading the graphical elements of the configuration tool, which are freely definable, into the configuration tool from a data storage medium.
